(19) United States
(12) Patent Application Publication
(10) Pub. No.: US 2017/0185969 A1
(43) Pub. Date: Jun. 29, 2017

(54) SYSTEM AND METHOD FOR AUTOMATED MANAGING OF SERIALLY PRODUCED TECHNICAL COMPONENTS

(71) Applicant: BipOn AB, Borås (SE)

(72) Inventors: Tony DAVIDOV, Borås (SE); Kenneth DAVIDOV, Borås (SE); Klas EKSTRAND, Billdal (SE); Martina WETTIN, Vallda (SE)

(73) Assignee: BipOn AB, Borås (SE)

(21) Appl. No.: 15/313,374

(22) PCT Filed: May 27, 2014
(86) PCT No.: PCT/SE2014/050647

§ 371 Date: Nov. 22, 2016

(51) Int. Cl. G06Q 10/00; G06Q 10/08; G08B 21/18; G06F 17/30

(52) U.S. Cl. CPC G06Q 10/20; G06F 17/30377; G06Q 10/0875; G08B 21/18

(57) ABSTRACT

A method and system for managing of an apparatus comprising a plurality of series produced technical hardware components over a life-cycle are disclosed. The method comprises assigning first identification data to the apparatus, assigning individual second identification data to all, or almost all, of said technical hardware components, and storing the first and second identification data in at least one of an external database and in a data storage in one or several of said apparatus and the technical hardware components. The first and second identification data provide a unique identification for each of said apparatus and technical hardware components, and each of said first and second identification data also comprises a plurality of identification data items related to different identification dimensions. This identification data may then be used for post-production service, upgrade, replacement and/or repair operations related to the apparatus and/or the technical hardware components.

### TECHNICAL FIELD

The present invention is related to a method and a system for automated or semi-automated managing of an apparatus comprising a plurality of series produced technical hardware components over a product life-cycle.

### BACKGROUND OF THE INVENTION

Many types of apparatuses, such as motors, construction and building equipment, aircrafts, cars, etc are formed of a plurality technical hardware components produced in series production, and subsequently assembled together. The planned and expected life cycle of such apparatuses can be very long, such as 5, 10 or 20 years, or even longer, and the apparatuses may be customized for various applications, etc, and be used at many different locations.

Systems for controlling technical components, or batches of components, during production, based on serial numbers or the like, are per se known, such as from U.S. Pat. No. 7,844,508, U.S. Pat. No. 5,751,581, U.S. Pat. No. 7,069,100, U.S. Pat. No. 8,282,008, US 2005/0234823, U.S. Pat. No. 7,937,751 and US 2011/0063093.

However, in the post-production operation, it is currently difficult or even impossible to control and manage the apparatuses efficiently. Over time, each apparatus is subject to regular or irregular service and maintenance, technical components within the apparatuses are replaced or repaired, software within the various components are upgraded or replaced, etc. There is a severe risk that the apparatus over time will perform non-optimally, or even malfunction completely. This may be due to the use of non-adequate service and maintenance, incompatible replacement parts, erroneous or non-optimal parameter settings, configuration, software, etc. Hereby, various components may not be used efficiently, or even used in a way which will inevitably lead to future failure, such as exceeding predetermined safety limits. Components may further, willfully or inadvertently be used in an erroneous application. Such problems will not only have the effect that the performance of the apparatus may be lowered, but may also lead to complete failure, which may reduce the operational life time of the apparatus. Frequent and long-lasting, and thus costly, production stops may also be expected. Further, such problems may also lead to safety hazards for the users of the apparatuses, and may lead to personal injuries and/or material damaging. A further cost related to such problems is lost confidence by the users, and loss in goodwill.

It is also, with currently available management systems, difficult to foresee problems related to certain components, to enable proactive measures to solve these problems prior to any failure or the like.

Accordingly, there is still a need for an improved method for managing series produced components during a life cycle.

### SUMMARY OF THE INVENTION

It is therefore an object of the present invention to provide a method and a system for managing of an apparatus comprising a plurality of series produced technical hardware components over a life-cycle which at least partly alleviates the above-discussed problems. In particular, it is an object to provide automated or semi-automated managing of apparatuses and series produced technical components over a product life cycle.

This object is obtained by means of a method and a system in accordance with the appended claims.

According to a first aspect of the invention, there is provided a method for managing of an apparatus comprising a plurality of series produced technical hardware components over a life-cycle, the method comprising:

assigning first identification data to said apparatus;

assigning individual second identification data to all, or almost all, of said technical hardware components;

storing said first and second identification data in at least one of an external database and in a data storage in one or several of said apparatus and said technical hardware components;

wherein said first and second identification data provide a unique identification for each of said apparatus and technical hardware components, and wherein each of said first and second identification data comprises a plurality of identification data items related to different identification dimensions; and

using said first and second identification data for post-production service, upgrade, replacement and/or repair operations related to said apparatus and/or said technical hardware components.

In the context of the present application, technical hardware components relate to hardware components produced in series production, preferably in relatively large quantities. From a hardware point of view, the components are essentially identical, but they may be provided with different software, be arranged in different configurations together with other components, may be used in different applications and apparatuses, and may be used for various purposes, i.e. perform different types of operations in use. For example, identical hydraulic valves may be produced in series production, and may then be used in different types of applications, such as in building equipment, industrial trucks and the like, and may be used for different purposes, such as controlling the flow at various positions and for different purposes within a hydraulic system. The technical components together form an apparatus, and such apparatuses, identical or customized in various ways, may be produced in large quantities, and be used locally or regionally, or all over the world.

The present invention is based on the realization that by providing improved means for identification and traceability of not only the apparatus in itself, but also each of the technical hardware components forming said apparatus, adequate function and operation of the apparatus can be maintained during its entire life-cycle. This leads to an increased longevity of the apparatuses and improved operation performance over time, which leads to more cost-efficient apparatuses when considering the overall life cycle costs. Further, this alleviates the risks and costs related to degraded functionality, malfunction, etc. of the apparatuses after post-production operations, such as services, repairs, replacements and upgrades of the technical hardware components. By means of multi-dimensional identifications of the present invention, identification and communication with individual technical components can be performed very efficiently. The multi-dimensional identities make it possible to identify individual components, or groups of components, and communicate efficiently with these, thereby enabling an efficient management of both the components and the apparatuses.

In presently available product management systems, the components are, at best, provided with one-dimensional identification, such as being provided with an article number, a serial number, or the like. However, such systems are inadequate to provide any remedy over the life cycle of the products. By means of the present invention, identifications for each, or about each, of the technical hardware components are provided, and further, the use of identification data comprising a plurality of identification data items related to different identification dimensions provide a much improved and more complete knowledge of the apparatus and the components therein. Preferably, the identification dimensions include a mix of dynamic and static data items. The static data items, such as individual identification, e.g. unique serial number, product type identification, such as article number, product name and type of technical application, production related identification, such as batch number and production date, assembling related identification, such as assembly configuration, assembly order, assembling date, etc may be fixed from the start, and never changed. The dynamic data items may be changed over the lifetime of the apparatus and/or components. The dynamic data items may e.g. be identification of software stored therein, executable by said apparatus or components, operational use related identification, such as date when brought into operation, type of use, user identification, geographical location, e.g. GIS or GPS position, post-production maintenance, service, replacement and repair related identification, such as date and type of service and/or repair, service technician and inspector identification, and date and type of replacements and/or upgrades, sub-identifications, such as identities of components being part of or related to another apparatus or component, and/or customer related identification, such as complaints and guarantees.

By means of the present invention, continuous updating and control of e.g. article numbers, batch numbers, manufacturing date, date of initiation of operation, data related to the operation, data related to service and maintenance, complaints, data related to upgrading, repair and replacements, etc can easily be maintained for both the entire apparatuses and the individual components for the longevity of the products and components. Further, continuous monitoring and updating of identification dimensions related to e.g. configuration of the apparatuses, data related to the initiation of operation and data related to the operation itself, for each individual technical component in the product series, makes it possible to discover, at an early stage, inaccuracies, abnormalities, systematic malfunction etc. It also makes it possible to foresee such problems based on e.g. trend analysis. This lower maintenance and repair costs, and enhance the operational life time and operation performance of the components and apparatuses. It also makes it easier and less costly to handle various forms of guarantees related to the apparatuses and components.

Still further, continuous monitoring and updating of identification dimensions related to e.g. configuration and operation of each technical component in a product series makes it possible to ensure that the components are installed correctly in the apparatuses and applications, with correct parameters and configurations, and with correct software, and that any deviations from this could be easily detected and corrected. This also enhances the overall performance and security, since the components are then operated optimally, in line with predetermined safety regulations, alleviating the risk of operational stops, material damages, personal injuries, etc.

Management of technical components may, theoretically, be handled by paper notes, or in spreadsheet applications. However, this is practically feasible only for very short product series, and for a limited period of time. For longer series, and more complex components and apparatuses, such approaches soon become impractical or even impossible. Furthermore, the complexity of such administration increases exponentially over time. The present approach, using multidimensional identities, provides an efficient remedy to this, which may also be operated in an automated or semi-automated fashion. It also provides a system which is easily made compatible with other production and sales management systems, and which provides a very good transparency. Further, the efforts in form of costs and time for managing product series in the presently presented way does not increase exponentially over time, as would be the case in many other possible solutions, but remain at a fairly constant level.

At least one of said identification data items is preferably common to several technical hardware components, said common identification data items e.g. being related to the application or apparatus in which the technical hardware components are used.

The first and second identification data may be stored in various locations throughout the system. The data may be at least partly duplicated, and stored at separate locations/entities. However, the complete data may also be stored at a single location, or be stored distributed at different locations.

The first and second identification data are preferably stored, at least partly, in one or several of said apparatus and said technical hardware components, said first and second identification data being retrievable by external equipment.

This provides a distributed storage system, where each apparatus, and preferably even each technical component, in itself stores the relevant identification data. This makes the system easily scalable, and also makes the relevant data accessible directly, whenever it is needed, such as in service and repair facilities around the globe.

Additionally or alternatively, the first and second identification data may also at least partly be stored in other technical components of the same apparatus, or by technical components or apparatuses outside the apparatus to which the first and second identification data relates.

The first and second identification data may also, completely or to some extent, be stored in an external database. Arrangement of such a central database facilitates statistical evaluation, detection of trends, etc.

Updating and completion of the identification data is preferably made automatically or semi-automatically over time, as a result of status changes, operational changes, configuration changes, etc. However, the identification data may also, at least partly, be provided and/or handled manually. For example, batch number, article number and/or logical identity numbers may be physically stamped, engraved or in other ways assigned to the components.

By storing parameters, configurations, software identification, etc. related to the individual components, or the aggregate apparatus, and preferably in the components and/or apparatus themselves, it becomes easy to ensure that correct parameter settings and configurations are used e.g. when a component is replaced, upgraded or refurbished. The technical structure of the apparatus/application is also preferably derivable from the first and/or second identification data.

Further, technical function, security settings, etc. of the components and/or apparatuses, are also preferably derivable from the multi-dimensional identification data.

Further, the method preferably comprises the step of updating, preferably automatically, at least one of said first and second identification data following post-production operations leading to an altered status for said apparatus.

Still further, the method preferably comprises the step of automatically issuing an alarm if one of said first and second identities has been amended in an unwarranted way. In particular, the structure of an apparatus/application is preferably derivable from the identities of the included components, and an alarm may be generated when changes in the structures identities have taken place.

The plurality of identification data items related to different identification dimensions are preferably related to at least two, and preferably at least three, of the identification dimensions:
individual identification, such as unique serial number;
product type identification, such as article number, product name and type of technical application;
production related identification, such as batch number and production date;
assembling related identification, such as assembly configuration, assembly order, assembling date, identification of software stored therein, executable by said apparatus or components;
operational use related identification, such as date when brought into operation, type of use, user identification, geographical location, e.g. GIS or GPS position;
post-production maintenance, service, replacement and repair related identification, such as date and type of service and/or repair, service technician and inspector identification, and date and type of replacements and/or upgrades;
sub-identifications, such as identities of components being part of or related to another apparatus or component; and
customer related identification, such as complaints and guarantees.

The identification data may also comprise additional information, such as extra control digits and the like. The identification data may also comprise a check sum or hash sum, for verification.

The total multi-dimensional identification data for each component and apparatus is preferably unique, capable of uniquely identifying a single item. However, some, most or even all of the constituent parts/dimensions of the identification data need not be unique, but may instead be common between multiple components of similar type, between components within one and the same apparatus etc.

In addition to identification data related to apparatuses and components, persons involved with the production, operation and/or maintenance of the apparatuses may also be assigned unique identities, which may then be added as further dimensions in the identification data of the components or apparatus, making it possible to determine, from the identification data of the apparatus/components itself, persons that have been involved with the apparatus, during e.g. manufacturing, repair, maintenance, normal operation, etc.

Identification data is preferably generated automatically or semi-automatically, but can also, at least to some extent, be created manually. For example, dimensions such as unique serial numbers, batch numbers, etc. may be assigned either manually or automatically, whereas dimensions such as assembly structure/configuration, sub-identities for other related components, etc. are preferably assigned automatically. The automated assignment of dimensions to the identification data may be achieved by bidirectional communication with related components, by retrieving data from external sources, such as production management systems, etc.

Further, the method preferably comprises the step of automatically assigning new second identification data to a technical component of the apparatus not previously having second identification data assigned thereto, said new second identification data being a unique identification formed at least partly by previously available first and second identification data related to the apparatus and the other technical components of the apparatus.

If a technical component in an apparatus lacks identification data, e.g. by being added to the apparatus/application, such a technical component may be assigned identification data automatically, e.g. by the apparatus/application itself. Such newly assigned identification data may e.g. comprise sub-identities of one or several or all of the other technical components of the apparatus/application. If necessary, in order to make the newly assigned identification data unique, extra identification dimensions may be added, such as a serial number or the like.

If a technical component “A” is in contact with another technical component “B”, A may typically be added as a sub-identity dimension in the identification data of B, and vice versa.

Within an apparatus/application, at least one of the technical components may be assigned a higher hierarchical level than other technical components of the apparatus/application. In that case, the technical component(s) of a higher hierarchical level is preferably responsible for assigning new identification data to technical components of a lower hierarchical level under its control, and for updating the identification data of such technical components.

According to another aspect of the invention, there is provided a system for managing of an apparatus comprising a plurality of series produced technical hardware components over a life-cycle, the system comprising:

at least one data storage for storage of first identification data assigned to said apparatus and individual second identification data assigned to all, or almost all, of said technical hardware components, said data storage being arranged as at least one of an external database and a data storage in one or several of said apparatus and said technical hardware components;

wherein said first and second identification data provide a unique identification for each of said apparatus and technical hardware components, and wherein each of said first and second identification data comprises a plurality of identification data items related to different identification dimensions; and

a controller being arranged to retrieve said first and second identification data, to use this for controlling post-production service, upgrade, replacement and/or repair operations related to said apparatus and/or said technical hardware components, and to update at least one of said first and second identification data following such post-production service, upgrade, replacement and/or repair operations.

By means of this aspect of the invention, similar advantages and possible embodiments as discussed above in relation to the first aspect are obtainable.

At least one of said identification data items is preferably common to several technical hardware components, said common identification data items e.g. being related to the application or apparatus in which the technical hardware components are used.

The data storage is preferably arranged in at least one or several of said apparatus and said technical hardware, for storing of said first and second identification data, said first and second identification data being retrievable by said controller.

The controller may further be arranged to automatically issue an alarm if one of said first and second identities has been amended in an unwarranted way.

Further, the system preferably comprises a display to visualize retrieved identification data related to the apparatus and/or the technical components. The display may be integrated with the apparatus formed by the components, or be arranged in a separate, external unit.

The controller is further arranged to communicate with at least one of the apparatus and the technical components therein by means of bidirectional communication.

The controller is preferably arranged to communicate with at least one of the technical components of the apparatus indirectly, via another technical component of the apparatus. Hereby, an indirect communication channel is established, allowing the technical component to communicate its multi-dimensional identification data.

The communication between external equipment and the technical components and apparatuses may use any communication channel. For example, identification of components and communication of the multi-dimensional identity data may take place by wireless radio communication, optical communication, sound based communication, wired data communication, etc.

Storing of identification data in memory devices, such as in RFID chips, or other storage means, etc, either on components/devices, or in central databases, and communicating data to and from such memory devices, are per se well known in the art, and e.g. disclosed in U.S. Pat. No. 7,844,508, U.S. Pat. No. 5,751,581, U.S. Pat. No. 7,069,100, U.S. Pat. No. 8,282,008, US 2005/0234823, U.S. Pat. No. 7,937,751 and US 2011/0063093, each of said documents hereby being incorporated by reference.

Further embodiments, preferred features and advantages of the present invention will become apparent from the following detailed description of presently preferred embodiments of the invention.

### BRIEF DESCRIPTION OF THE DRAWINGS

By way of example, embodiments of the invention will now be described with reference to the accompanying drawings in which:

FIG. 1 shows a schematic representation of an apparatus comprising a plurality of series produced technical components, manageable by means of embodiments of the present invention;

FIG. 2 is a schematic representation of the apparatus of FIG. 1, when used in a larger system, and illustrating the interaction between the dimensions of identification data related to the apparatus;

FIG. 3 is a schematic representation of how technical components can be identified by means of multi-dimensional identification data in an embodiment of the present invention; and

FIG. 4 shows schematically a method for automated managing of series produced technical components by means of multi-dimensional identification data through a central database, in accordance with a further embodiment of the present invention.

### DETAILED DESCRIPTION OF PREFERRED EMBODIMENTS

In the following detailed description preferred embodiments of the invention will be described. However, it is to be understood that features of the different embodiments are exchangeable between the embodiments and may be combined in different ways, unless anything else is specifically indicated. Even though in the following description, numerous specific details are set forth to provide a more thorough understanding of the present invention, it will be apparent to one skilled in the art that the present invention may be practiced without these specific details. In other instances, well known constructions or functions are not described in detail, so as not to obscure the present invention.

FIG. 1 illustrates, in a schematic way, a simple apparatus comprising four series produced technical components, here in the form of four gear wheels. However, it is to be acknowledged by the skilled reader that this is just a simplified representation, and naturally the technical components may be of more complex nature, and the aggregate apparatus may comprise fewer or more constituent technical components. The apparatus may also comprise technical components which are all different, or two or more technical components being similar or identical to each other. In the illustrative example of FIG. 1, there are two pairs of gear wheels, wherein the gear wheels within each pair are of the same type, and practically identical to each other.

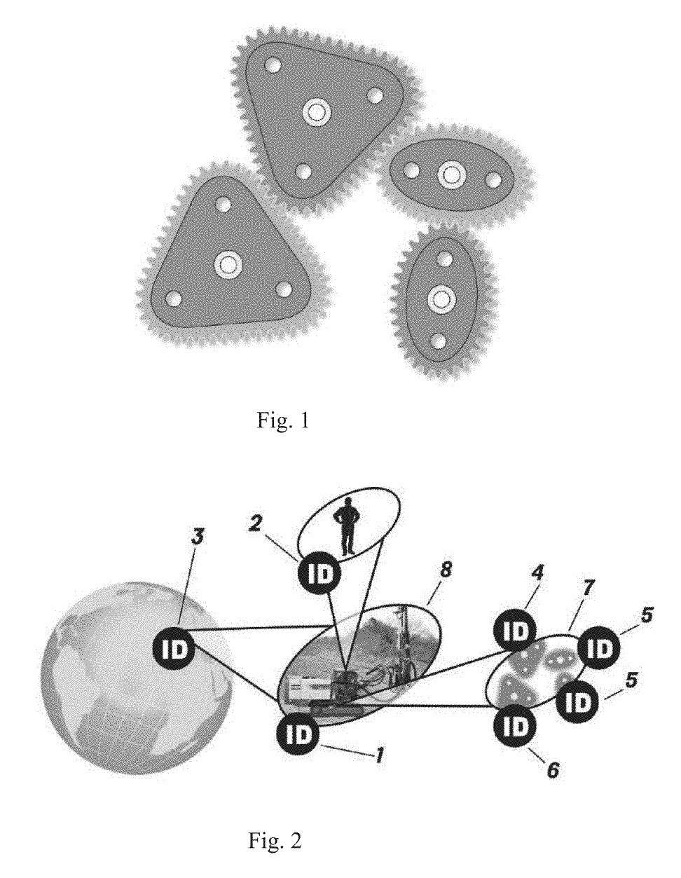

In FIG. 2, the apparatus of FIG. 1 is used in a more complex system, here a pile-driving machine. FIG. 2 further illustrates how, in accordance with the invention, multi-dimensional identification data assigned to each series produced component, as well as to the apparatus itself, can comprise multiple dimensions, and how these identities co-exist and interact with each other.

In the illustrative example of FIG. 2, the multi-dimensional identification data assigned to any one, or all, of the technical components of the apparatus of FIG. 1, may comprise some, and preferably all, of the following dimensions:
1. An identity of the system in which the apparatus/components are used, such as production or model name. In this example, this dimension relates to the pile-driving machine.
2. An identity of a user of the system, such as the identity of the operator(s), service technicians, inspectors, etc.
3. An identity of the geographical location where the pile-driving machine is used, e.g. based on GIS or GPS position.
4. A hardware/product identity, such as serial number, article number or batch number.
5. An identity relating to the order in which the components are arranged, such as the order in which they are assembled together.
6. A sub-identity, such as identities of components being part of or related to the technical component.
7. An identity related to the technical application for the apparatus, such as being part of a motor within the pile-driving machine.
8. An identity related to the type of system in which the application is used, such as being a pile-driving machine.

Preferably, all constituent technical components, as well as aggregate apparatuses, are provided with multi-dimensional identification data of this type. However, the set of dimensions (identities) used for each component or apparatus may vary.

All the above-discussed illustrated components and apparatuses/applications are examples of various dimensions related to identification data. At least some of these identities/dimensions can be identified automatically, whereas others may need to be identified or specified manually.

If all technical components apart from one within an apparatus have unique identities, the remaining technical component will also, automatically have an identity, since the remaining technical component will then be uniquely identifiable as the remaining technical component being associated with the others and not having a separate identity.

The apparatus of FIG. 2 can preferably by itself identify various conditions, etc, and provide signals to the constituent components of corresponding changes in the identification data.

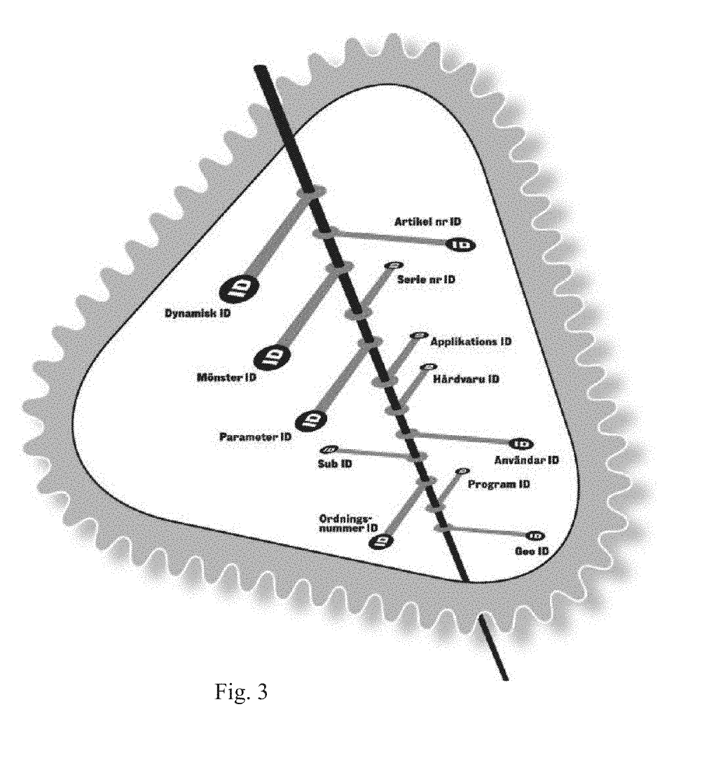

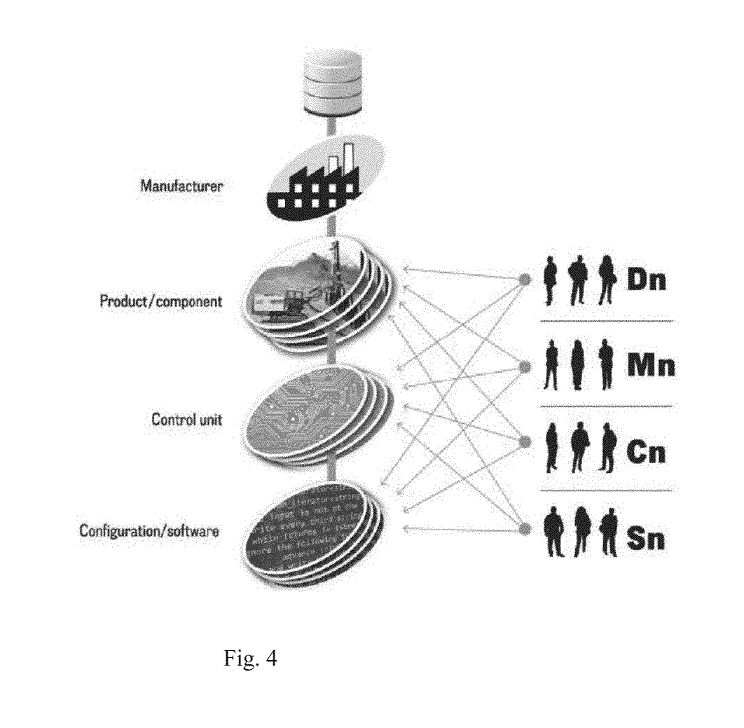

In FIG. 3, different dimensions of identification data related to a technical component are further illustrated. In this example, the dimensions are: dynamic ID, article number ID, pattern ID, series/batch number ID, parameter ID, application ID, hardware ID, user ID, sub-ID, order number ID, program ID and geographical ID. Also, the following dimensions related to external parties may be added: manufacturer ID and customer/client ID. The identification data may be stored directly on the technical component, such as in a memory, on a chip, or the like. However, the identification data may also, partly or wholly, be stored in another component/apparatus, or in an external database. Further, as discussed above in relation to FIG. 2, the identity of user(s) of the apparatus, etc, may also be comprised as dimensions/identities in the identification data for the technical component.

The identification data is preferably stored on the component or in the apparatus in such a way that it can be communicated to external devices, etc. Hereby, it is e.g. possible to establish communication between the components/apparatuses and a central external database. However, not all apparatuses/components need to have direct communication access to such an external device or external database. Instead, apparatuses or components may communicate indirectly, through other components or apparatuses. Preferably, such indirectly communicating components or apparatuses are identified as sub-identities for the directly communicating component or apparatus.

Preferably, the identification data comprises a mix of dynamic, updatable dimensions/identities, and static dimensions/identities. By the use of multiple dimensions/identities, the technical components will remain uniquely identifiable even when some dimensions/identities are updated or replaced.

For example, in the illustrative example of FIG. 3, all dimensions/identities need not be satisfied to uniquely identifying the technical component or apparatus. The technical component of FIG. 3 may be identified e.g. by the time it was first started, or every time it was restarted. Such an identity is dynamic, and may be created initially, but may then be continuously updated and changed. It may also be identified by the article number of a certain production series, or by a physical serial number, or by a virtual serial number assigned by a central database. It may also be identified by the physical constitution, and/or by the software it is operating. It may also be identified by its geographical position, by its position within the apparatus, or its order of assembly. It may also be identified, by means of a temporary identity, based on changing conditions, such as queue position, pattern of movement or performance pattern.

By the identification of technical components in several dimensions, it becomes possible to automatically trace, identify and at certain times register various new or updated dimensions/identities in the identification data, such as article numbers, serial numbers, date of manufacturing, date of initiation of operation, operational data, service and maintenance, reclamation or complaints, warranties, repair and upgrade, etc. for each individual component in a series, until the components and/or apparatuses are phased out. This is illustrated schematically in FIG. 4. Together with a central database, the system for managing the series produced technical components may also operate relatively autonomously and automatically.

In FIG. 4, four categories of users of a system for automated managing of series produced technical components are illustrated. These categories are: developers (Dn), manufacturers (Mn), customers (Cn) and service providers (Sn).

In a practical example, it may be assumed that operations disturbances occur in an apparatus in the pile-driving machine of FIG. 2. The apparatus is directly or indirectly in bidirectional communication with a server, e.g. via a wireless telecommunications network, and the server is in turn connected to a central database.

In this case, a centrally operated system may identify the identity of the apparatus (1^{st} dimension) and in the apparatus included series produced technical components (2^{nd} dimension). This may e.g. reveal that a control circuit (3^{rd} dimension) needs to be replaced. The system may further identify where the apparatus/machine is located (4^{th} dimension), and which version of software (5^{th} dimension) it operates. It may also determine the configuration and set of parameters used by the control circuit (6^{th} dimension).

Using this identification data, the central system may automatically place an order to get a new control circuit, of the same type and provided with the same version of software and with the same configurations, to be sent directly to the operator (7^{th} dimension) of the machine. The central system may also request an acknowledgment when the new control circuit has been installed in the pile-driving machine, and may the update the status of the apparatus in the identification data.

Hereby, an efficient remedy is obtained to e.g. damages, malfunctioning, lowered performance, etc, on the component/apparatus, since the malfunctioning component can easily be traced and identified using multiple dimensions.

Another practical example, relates to a machine, e.g. the pile-driving machine of FIG. 2, which is not connected to a central control. It may now be assumed that operations disturbances occur due to a worn and malfunctioning bearing in the machine. The operator now replaces the bearing with a similar bearing from another apparatus. The apparatus can identify that a replacement has been made, based on the identification data, such as by means of hardware ID and serial number ID. Two scenarios are now feasible. In one scenario, the apparatus accepts the possible differences between the two bearings, and the machine works again. In another scenario, the apparatus will first request a new configuration, and possibly new software, in order to start operation. Selection of correct hardware, configuration etc can be accomplished by accessing the identification data of the apparatus and components. In both scenarios, the identification data is then updated with respect to hardware ID, serial number ID and software ID when the machine is brought in communication with a central system or an external control unit.

The person skilled in the art realizes that the present invention by no means is limited to the preferred embodiments described above. On the contrary, many modifications and variations are possible within the scope of the appended claims. The system preferably comprises a central unit, such as a central server, which is in continuous or intermittent contact with the various apparatus and components managed by the system, e.g. through a telecommunications network. However, the system may also be operated locally, by control units connectable to the apparatuses by wired connections and the like. Further, the multi-dimensional identification data may be stored solely on the components and apparatuses to which the identification data relates, or solely in an external database, or in both said locations. Such and other modifications should be construed to fall within the scope of the appended claims.

1. A method for managing of an apparatus comprising a plurality of series produced technical hardware components over a life-cycle, the method comprising:
assigning first identification data to said apparatus;
assigning individual second identification data to all, or almost all, of said technical hardware components;
storing said first and second identification data in at least one of an external database and in a data storage in one or several of said apparatus and said technical hardware components;
wherein said first and second identification data provide a unique identification for each of said apparatus and technical hardware components, and wherein each of said first and second identification data comprises a plurality of identification data items related to different identification dimensions; and
using said first and second identification data for post-production service, upgrade, replacement and/or repair operations related to said apparatus and/or said technical hardware components.

2. The method of claim 1, wherein at least one of said identification data items are common to several technical hardware components, said common identification data items e.g. being related to the application or apparatus in which the technical hardware components are used.

3. The method of claim 1, wherein said first and second identification data are stored in one or several of said apparatus and said technical hardware components, said first and second identification data being retrievable by external equipment.

4. The method of claim 1, wherein said first and second identification data are stored in an external database.

5. The method of claim 1, further comprising the step of updating at least one of said first and second identification data following post-production operations leading to an altered status for said apparatus.

6. The method of claim 5, further comprising the step of automatically issuing an alarm if one of said first and second identities has been amended in an unwarranted way.

7. The method of claim 1, wherein said plurality of identification data items related to different identification dimensions are related to at least two of the identification dimensions:
individual identification;
product type identification;
production related identification;
assembling related identification;
operational use related identification;
post-production maintenance, service, replacement and repair related identification;
sub-identifications; and
customer related identification.

8. The method of claim 1, further comprising the step of automatically assigning new second identification data to a technical component of the apparatus not previously having second identification data assigned thereto, said new second identification data being a unique identification formed at least partly by previously available first and second identification data related to the apparatus and the other technical components of the apparatus.

9. A system for managing of an apparatus comprising a plurality of series produced technical hardware components over a life-cycle, the system comprising:
at least one data storage for storage of first identification data assigned to said apparatus and individual second identification data assigned to all, or almost all, of said technical hardware components, said data storage being arranged as at least one of an external database and a data storage in one or several of said apparatus and said technical hardware components;
wherein said first and second identification data provide a unique identification for each of said apparatus and technical hardware components, and wherein each of said first and second identification data comprises a plurality of identification data items related to different identification dimensions; and
a controller being arranged to retrieve said first and second identification data, to use this for controlling post-production service, upgrade, replacement and/or repair operations related to said apparatus and/or said technical hardware components, and to update at least one of said first and second identification data following such post-production service, upgrade, replacement and/or repair operations.

10. The system of claim 9, wherein at least one of said identification data items are common to several technical hardware components, said common identification data items.

11. The system of claim 9, wherein said data storage is arranged in at least one or several of said apparatus and said technical hardware, for storing of said first and second identification data, said first and second identification data being retrievable by said controller.

12. The system of claim 9, wherein said controller is further arranged to automatically issue an alarm if one of said first and second identities has been amended in an unwarranted way.

13. The system of claim 9, further comprising a display to visualize retrieved identification data related to the apparatus and/or the technical components.

14. The system of claim 9, wherein the controller is further arranged to communicate with at least one of the apparatus and the technical components therein by means of bidirectional communication.

15. The system of claim 9, wherein the controller is arranged to communicate with at least one of the technical components of the apparatus indirectly, via another technical component of the apparatus.
